(19) United States
(12) Patent Application Publication
(10) Pub. No.: US 2007/0194749 A1
(43) Pub. Date: Aug. 23, 2007

(54) Contact-less communication system

(76) Inventors: Brad Albert Delanghe, Sunnyvale, CA (US); Aleksandr Mikhail Movshovich, Santa Clara, CA (US)

Correspondence Address: A Movskovich, 363 MacKolde Drive, Santa Clara, CA, 95051, US

(21) Appl. No.: 11/436,124

(22) Filed: Feb. 22, 2006

(51) Int. Cl. H02J 7/00

(52) U.S. Cl. 320/109

(57) ABSTRACT

Apparatus for providing a contact-less, bi-directional communication link between a power supplying module (PS) and a power consuming module (PC) having two links, one (L1) used for power, clock, and upstream data transfer, the other (L2) used as downstream data link. PS contains a power supply circuit and PC contains a simple rectifier. The non-rectified output of L1 is used to provide the clock to PC. Amplitude variations of the signal driving L1 are detected and used in PC (upstream data link). Data is transmitted from PC to PS by tapping the non-rectified signal from the output of L1, passing it through a switch, which alternates its polarity before being fed into L2. The phase relationship between signals at the input of L1 and the output of L2 provides the means for the downstream data transfer.

### CROSS-REFERENCE TO RELATED APPLICATIONS

U.S. Pat. No. 4,654,573, discloses a Power transfer device, wherein the apparatus for transferring electrical power between a power supplying apparatus and power consuming apparatus and having a separable high frequency transformer with a primary permanently mounted to the power supply apparatus and a secondary mounted about the power consuming apparatus. The power supply apparatus includes a power supply circuit comprising a ferrite core transformer and capacitor forming a parallel resonant circuit. A driver drives the primary coil of the transformer. Power is transferred across the inductor to the resonant circuit as portions of a sine wave. The power supply circuit also includes an internal current sensing circuit to shut current build-up down when current in the resonant circuit becomes too high, and an external control loop which senses power demands of the charging control circuit delivered via an optical communications link within the separable transformer.

This technique provides the user with efficient means of contact-less power transfer from one device to another. The method described in U.S. Pat. No. 4,654,573 allows not only power to be transferred but describes means to provide clocking of the power consuming apparatus as well as a feedback data link. Unfortunately, the U.S. Pat. No. 4,654,573 does not teach how to build an efficient bi-directional data link between both apparatus. An obvious problem of the method described in U.S. Pat. No. 4,654,573 is that the return data path requires significant energy consumption from the power consuming apparatus. It requires at least one LED to be powered on and thus effects the overall power balance of the system.

A need therefore exists for an improved means of providing contact-less power transfer between two devices coupled with an integrated bi-directional communication link, and consuming minimal amount of energy.

### FIELD OF THE INVENTION

This invention relates to an apparatus for transferring electrical power, and more specifically to a magnetic power connector for transferring power without electrically conductive contact. In addition it relates to an apparatus for establishing data communication, and more specifically to a synchronization and representation (modulation) of the data sent over the said data link.

### BACKGROUND OF THE INVENTION

A number of means are known in the prior art for transferring electrical power from a power supplier, such as a piece of power equipment, to another piece of equipment requiring power. In a majority of applications power transfer happens when both power supplier and power consumer are mechanically connected to each other with conductive elements. This type of power transfer is straightforward and efficient but can't be universally used in all imaginable applications. Sometimes this power connection must be detachable and must withstand thousands of cycles of connection/disconnection of the power source. Unshielded and usually exposed contact elements may be subject to electric shorts, which will cause damage of the power source part of the equipment. On the other hand the same contact elements may be dirty and cease being conductive thus causing the equipment to malfunction.

In some applications it is essential for the power source not only to supply power to the system, but also to provide all means necessary to maintain a reliable data link between two pieces of equipment. These means may include the system synchronization, system clock, data transmitter, and data receiver. All those additional links might require additional contacts and in case of extensive wear of the later due to the mentioned above thousands of cycles of connection/disconnection of the power source the overall reliability of the system becomes questionable.

Other means of transferring power to and between detachable pieces of equipment generally consists of converting the power into a form of radiation e.g. light or microwave, and directing it to a receiver on the mobile piece of equipment. Such power transfer is highly inefficient, and potentially hazardous to persons or objects exposed to the power beams. The system data transfer between the two mentioned pieces of equipment becomes wasteful, inefficient and unreliable.

It is known that in some applications the power is being transferred from the power supplier utilizing the resonant tank or a transformer. In such a case the tank circuit includes a ferrite core transformer with a split primary coil. The power is transferred to the secondary coil without using any mechanical contacts and is not being wasted. This type of the system is efficient and reliable in applications requiring just power transfer, like battery chargers, etc. Some applications, for example smart cards, assume that not only power has to be transferred to the card, but as well require the bi-directional data link to be established between the power supplier and the power consumer. This, above mentioned, data link requires the power source device to have the ability to:
Generate clock signal and synchronize the power consumer with this clock;
Communicate messages to the power consumer utilizing a predefined protocol;
Receive messages originated by the power consumer device. All of the above functions have to be performed with minimal power loss, reliably and with high fidelity of the transmitted data.

### SUMMARY OF THE INVENTION

An object of the present invention is to provide a device, which can transfer power between a fixed piece of equipment and a mobile piece of equipment.

Another object of the present invention is to provide power transfer not requiring a electrically conductive contact.

Another object of the present invention is to provide power transfer containing no exposed, current-carrying conductors.

Another object of the present invention is to provide power transfer requiring no frictional contact, and which may be used over an indefinite number of insertion cycles without wear.

Another object of the present invention is to provide a device with zero insertion force.

Another object of the present invention is to provide a device capable of providing a bi-directional communication channel between power supplier and power consumer.

Another object of the present invention is to provide a device capable of synchronizing a data transmitter and data receiver in power supplier and power consumer respectively by providing them both with the same clock.

Another object of the present invention is to provide a device utilizing the signal received from the power supplier to establish the downstream data path.

Briefly, the preferred embodiment of the present invention includes a separable transformer comprising two halves, each positioned in a housing with the housings being able to mate with one another. One half is mounted upon a power supplying module, the other half is mounted on a power consuming module. The power consuming module does not have any power source and completely relies on the power being transmitted from the power supplying module in order to operate. Upon engagement, the magnetic field induced in the transformer by the power supplying module will generate a sinusoidal waveform in the secondary coil of the transformer, which belongs to the power consuming module. A simple rectifier means provides the power consuming module with enough power to sustain its operation. The non-rectified sinusoidal wave on the secondary coil of the transformer is utilized as the clock signal providing the means for implementation of the synchronous data transfer between the power supplying module and the power consuming module.

The upstream data from the power supplying module to the power consuming module is transferred utilizing amplitude modulation (AM) of the voltage applied to the primary coil of the said transformer. Variations of the voltage applied to the primary coil causes the voltage induced in the secondary coil to changes its amplitude. The power consuming module detects those above mentioned changes of the amplitude of the voltage induced in the secondary coil of the transformer as elementary pieces of the data stream. Those above mentioned variations of the voltage should happen synchronous with the clock signal and not faster than once every 5-10 clock cycles. The above limitation to the speed of the data transfer is due to the fact that the performance of a simple rectifier, which provides the power consuming module with its power should not be effected.

The downstream data path (from the power consuming module back to the power supplying module) should be implemented using the second separable transformer comprising exactly like the first one comprising of two halves, each positioned in a separate housing with the housings being able to mate with one another. The voltage being picked up from the secondary coil of the first transformer is fed to the primary coil of the second transformer to provide the downstream data path. The power supplying module contains the means to compare the phase of the voltage supplied to the primary coil of the first transformer and the voltage picked up from the secondary coil of the second transformer. If there is no data communication, the mentioned phase difference will be constant. When data is meant to be transmitted from the power consuming module, the ends of the primary coil of the second transformer are switched in such a way that the voltage induce in its secondary coil changes its phase by 180 degrees. This switching operation does not require additional power consumption in the power consuming module and at the same time is very noticeable at the output of the said phase comparator located in the power supplying module.

An advantage of the present invention is that the suggested system provides all necessary means for implementation of the synchronous bi-directional data link;

Another advantage of the present invention is that the suggested implementation of the downstream data link does not consume any additional power in the power consuming module;

Another advantage of the present invention is that the upstream data link does not require an additional separate transformer;

Another advantage of the present invention is that the clock synchronization doe not require an additional separate transformer.

These and other objects and advantages of the present invention will no doubt become obvious to those of ordinary skill in the art after having read the following detailed description of the preferred embodiments as illustrated in the various drawing figures.

### IN THE DRAWINGS

FIG. 1 is a semi-schematic diagram of hardware for practicing the teachings of this invention in configuration 1 (second inductive link for the downstream data link using phase modulation).

FIG. 2 is a semi-schematic diagram of hardware for practicing the teachings of this invention in configuration 4 (second inductive link for the downstream data link using phase modulation with a crossbar switch and a phase comparator).

FIG. 3 is a semi-schematic diagram of hardware for practicing the teachings of this invention in configuration 5 (optical link for the downstream data link).

### DETAILED DESCRIPTION OF THE INVENTION

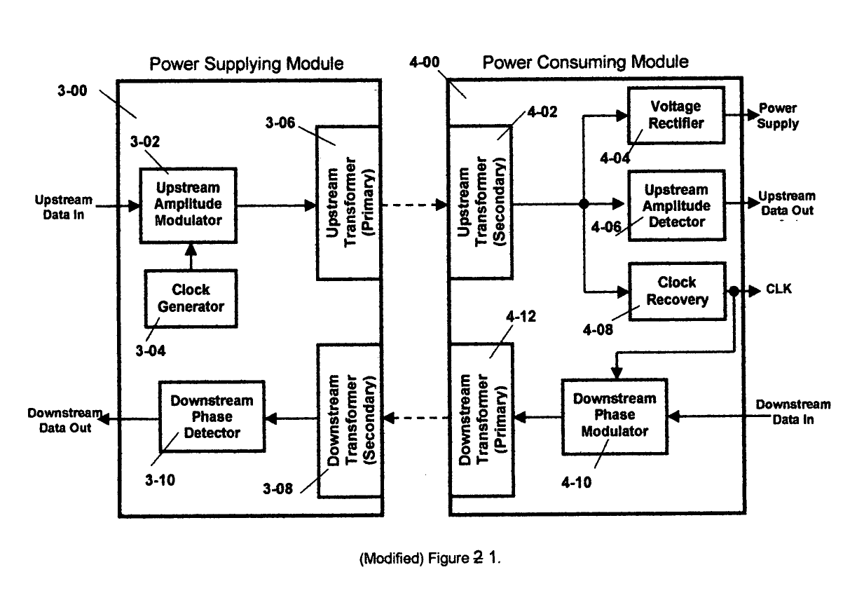

FIG. 1 illustrates the two basic components of a system utilized in practicing the teachings of this invention, these components being a power supplying module 3-00, and a power consuming module 4-00. A clock signal of fixed frequency is generated from the clock generation block 3-04. This dock signal, used as the carrier signal, and the upstream input data, used as the envelope or upstream modulating signal, are both sent to the upstream amplitude modulation block 3-02 in order to create the upstream modulated signal. This magnetic coupling allows the upstream modulated signal to pass from the upstream transformer half primary 3-06 of the power supplying module 3-00 to the upstream transformer half secondary 4-02 of the power consuming module 4-00. The upstream modulated signal, now at the output of the secondary windings of the upstream transformer half is simultaneously sent to the voltage rectifier block 4-04, the upstream amplitude detector block 4-06 and the clock recovery block 4-08. The voltage rectifier block 4-04 generates a constant DC voltage which is sent out of the power consuming module 4-00. The upstream amplitude detector 4-06 removes the envelope from the upstream modulated signal to recover the original upstream data. The upstream data is then sent out of the power consuming module 4-00. The clock recovery block 4-08 removes the carrier signal from the upstream modulated signal and then cleans it up before sending it out of the power consuming module 4-00.

In order to pass data from the power consuming module 4-00 to the power supplying module 3-00 a second (downstream) data link is set up. In this embodiment of the invention the second data link is inductive. The output of the clock recovery block 4-08, used as the carrier signal, and the downstream input data, used as the downstream modulating signal, are sent to the downstream phase modulation block 4-10 in order to create the downstream modulated signal. The downstream modulated output of the downstream amplitude modulation block 4-10 is sent to the primary windings of the downstream transformer half 2-12 where a magnetic coupling is set up by the alternating voltage of the downstream modulated signal. This magnetic coupling allows the downstream modulated signal to pass from the downstream transformer half primary 4-12 of the power consuming module 4-00 to the downstream transformer half secondary 3-08 of the power supplying module 3-00. The downstream modulated signal, now at the output of the secondary windings of the downstream transformer half 3-08 is sent to the downstream phase detector 3-10. The downstream phase detector 3-10 removes the modulating signal from the downstream modulated signal to recover the original downstream data. The downstream data is then sent out of the power supplying module 3-00.

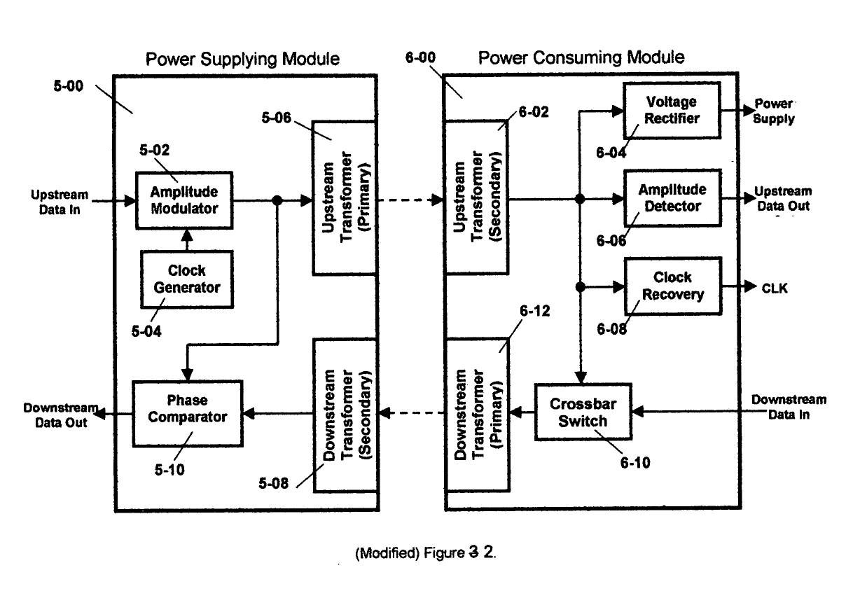

FIG. 2 illustrates the two basic components of a system utilized in practicing the teachings of this invention, these components being a power supplying module 5-00, and a power consuming module 6-00. A clock signal of fixed frequency is generated from the clock generation block 5-04. This clock signal, used as the carrier signal, and the upstream input data, used as the envelope or upstream modulating signal, are sent to the upstream amplitude modulation block 5-02 in order to create the upstream modulated signal. The upstream modulated output of the upstream amplitude modulation block 5-02 is sent to the primary windings of the upstream transformer half 5-06 where a magnetic coupling is set up by the alternating voltage of the upstream modulated signal. This magnetic coupling allows the upstream modulated signal to pass from the upstream transformer half primary 5-06 of the power supplying module 5-00 to the upstream transformer half secondary 6-02 of the power consuming module 6-00. The upstream modulated signal, now at the output of the secondary windings of the upstream transformer half is simultaneously sent to the voltage rectifier block 6-04, the upstream amplitude detector block 6-06 and the clock recovery block 6-08. The voltage rectifier block 6-04 generates a constant DC voltage which is sent out of the power consuming module 6-00. The upstream amplitude detector 6-06 removes the envelope from the upstream modulated signal to recover the original upstream data. The upstream data is then sent out of the power consuming module 6-00. The clock recovery block 6-08 removes the carrier signal from the upstream modulated signal and then cleans it up before sending it out of the power consuming module 6-00.

In order to pass data from the power consuming module 6-00 to the power supplying module 5-00 a second data link is set up. In this embodiment of the invention the second data link is inductive where the output of the secondary windings of the upstream transformer half 6-02 is sent directly to a crossbar switch 6-10 along with the downstream input data. By using the downstream input data as the control in order to cross connect the output of the secondary windings of the upstream transformer half a simple phase modulation scheme is set up. The downstream modulated output of the crossbar switch 6-10 is sent to the primary windings of the downstream transformer half 6-12 where a magnetic coupling is set up by the alternating voltage of the downstream modulated signal. This magnetic coupling allows the downstream modulated signal to pass from the downstream transformer half primary 6-12 of the power consuming module 6-00 to the downstream transformer half secondary 5-08 of the power supplying module 5-00. The downstream modulated signal, now at the output of the secondary windings of the downstream transformer half 5-08 is sent to a phase comparator 5-10 along with the input of the primary windings of the upstream transformer half 5-06. The relationship between the phase of the input of the primary windings of the upstream transformer half 5-06, which is constant, and the phase of the output of the secondary windings of the downstream transformer half 5-08, which is phase modulated, is used to recover the original downstream data. The downstream data is then sent out of the power supplying module 500.

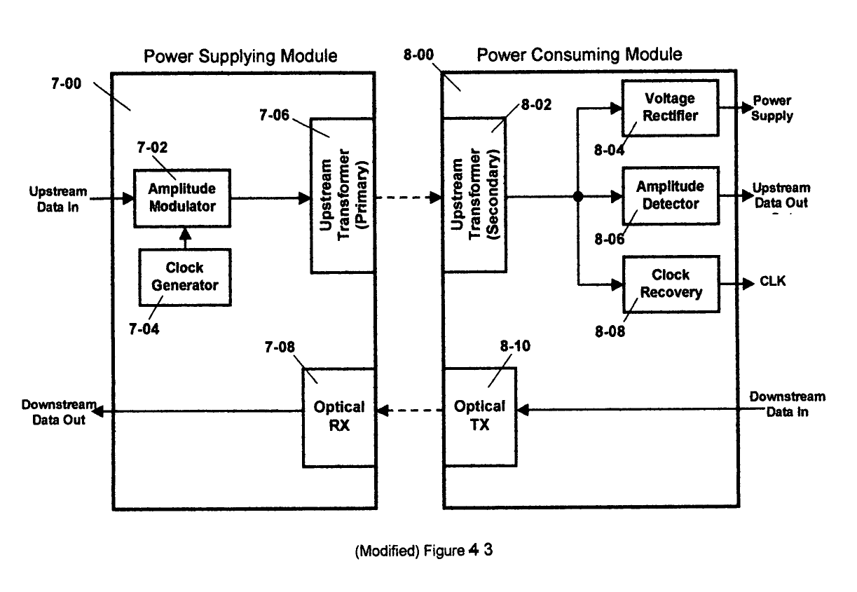

FIG. 3 illustrates the two basic components of a system utilized in practicing the teachings of this invention, these components being a power supplying module 7-00, and a power consuming module 8-00. A clock signal of fixed frequency is generated from the clock generation block 7-04. This clock signal, used as the carrier signal, and the upstream input data, used as the envelope or upstream modulating signal, are both sent to the upstream amplitude modulation block 7-02 in order to create the upstream modulated signal. The upstream modulated output of the upstream amplitude modulation block 7-02 is sent to the primary windings of the upstream transformer half 7-06 where a magnetic coupling is set up by the alternating voltage of the upstream modulated signal. This magnetic coupling allows the upstream modulated signal to pass from the upstream transformer half primary 7-06 of the power supplying module 7-00 to the upstream transformer half secondary 8-02 of the power consuming module 8-00. The upstream modulated signal, now at the output of the secondary windings of the upstream transformer half is simultaneously sent to the voltage rectifier block is 8-04, the upstream amplitude detector block 8-06 and the clock recovery block 8-08. The voltage rectifier block 8-04 generates a constant DC voltage which is sent out of the power consuming module 8-00. The upstream amplitude detector 8-06 removes the envelope from the upstream modulated signal to recover the original upstream data. The upstream data is then sent out of the power consuming module 8-00. The clock recovery block 8-08 removes the carrier signal from the upstream modulated signal and then cleans it up before sending it out of the power consuming module 8-00.

In order to pass data from the power consuming module 8-00 to the power supplying module 7-00 a second data link is set up. In this embodiment of the invention the second data link is optical where the downstream input data is sent to the downstream optical transmitter 8-10. The optical transmitter sends the downstream data to an optical receiver 7-08 on the power supplying module 7-00, where the original downstream data is recovered and then sent out of the power supplying module 7-00.

What is claimed is:

1. Apparatus for contact-less communications system comprising:
a separable transformer means including a primary upstream transformer half and a secondary upstream transformer half adapted for magnetic coupling, at least one of said halves having a core of ferrite material for operating at the maximum upstream bit rate;
a voltage rectifying means with input connected to the said secondary upstream transformer half for creating a constant DC voltage from the alternating voltage induced in the secondary upstream transformer half by the primary upstream transformer half and driving the power supply output;
a clock recovery circuit connected to the said secondary upstream transformer half;
a clock generation means;
an amplitude modulation means, which inputs are connected to the outputs of the clock generator and a n upstream data input, used to induce an amplitude modulated upstream data in the primary upstream transformer half, said data being sent through an inductive link set up by the primary and secondary upstream transformer halves;
a data recovery circuit connected to the said secondary upstream transformer half; including an amplitude detector means for receiving the upstream data sent via the inductive link set up by the primary and secondary upstream transformer halves and driving an upstream data out;
a second contact-less communications means to provide a downstream data link;
a downstream phase modulation means with input connected to a downstream data in and controlled by the output of the clock recovery circuit, with its output connected to a primary downstream transformer half;
a downstream data recovery circuit including a downstream phase detector means connected to a secondary downstream transformer half and driving a downstream data out.

2. Apparatus for contact-less communications system as per claim 1, where
a downstream phase modulation means implemented as a crossbar switch controlled by a downstream data in with its input connected to the said secondary upstream transformer half and with its output connected to the said primary downstream transformer half;

3. Apparatus for contact-less communications system as per claim 1, where
a downstream phase modulation means implemented as a crossbar switch controlled by the downstream data in with its input connected to the said secondary upstream transformer half, and with its output connected to the said primary downstream transformer half;
a downstream data recovery circuit including a phase comparator means which input is connected to the secondary downstream transformer half, controlled by the output of the amplitude modulator and driving a downstream data out.

4. Apparatus for contact-less communications system as per claim 1 where
a downstream data recovery circuit including a phase comparator means which input is connected to the secondary downstream transformer half, controlled by the output of the amplitude modulator and driving a downstream data out.

5. Apparatus for contact-less communications system as per claim 1, where the downstream data link is implemented as an optical link;
an amplitude modulation means including an infrared diode to transmit the downstream data;
a downstream data recovery circuit including an infrared photo diode to receive the downstream data;

6. Apparatus for contact-less communications system as per claim 1, where the downstream data link is implemented as an optical link;
an amplitude modulation means including a light emitting diode to transmit the downstream data;
a downstream data recovery circuit including a light emitting photo diode to receive the downstream data.

7. Apparatus for contact-less communications system as per claim 3, where the phase comparator is controlled by the output of the clock generator.

8. Apparatus for contact-less communications system as per claim 4, where the phase comparator is controlled by the output of the clock generator.
